(19) United States
(12) Patent Application Publication
(10) Pub. No.: US 2002/0009868 A1
(43) Pub. Date: Jan. 24, 2002

(54) Method of growing a thin film in gaseous phase and apparatus for growing a thin film in gaseous phase for use in said method

(75) Inventors: Shyuji Tobashi, Hiratsuka-city (JP); Tadashi Ohashi, Kudamatsu-city (JP); Katsuyuki Iwata, Hamamatsu-city (JP); Takaaki Honda, Numazu-city (JP); Hideki Arai, Numazu-city (JP); Kunihiko Suzuki, Shizuoka (JP)

Correspondence Address: Richard L. Schwaab, FOLEY & LARDNER, Washington Harbour, 3000 K Street., N.W., Suite 500, Washington, DC, 20007-5109, US

(73) Assignee: TOSHIBA CERAMICS CO., LTD.

(21) Appl. No.: 09/854,672

(22) Filed: May 15, 2001

(30) Foreign Application Priority Data
Jun. 9, 2000 (JP) 2000-173013

(51) Int. Cl. B05C 11/02

(52) U.S. Cl. 438/610; 118/100

(57) ABSTRACT

An improved method of growing a thin film in gaseous phase maintaining a uniform thickness and uniform electric properties such as resistivity, etc. over the whole surface of the film, and an apparatus for growing a thin film in gaseous phase adapted to conducting the above method. A method grows the thin film in gaseous phase by flowing down a film-forming reaction gas through plural gas feed ports 1, 2 formed in the top portion of a cylindrical reactor of an apparatus for glowing a thin film in gaseous phase via flow stabilizer plates 3, and bringing the film-forming reaction gas into contact with the wafer substrate A placed on a rotary susceptor 4 disposed on the lower side thereby to grow a thin film on the surface of the substrate, wherein space formed by the inner wall at the top portion of the reactor B and the flow stabilizer plates 3 is sectionalized into plural spatial sections in a concentric manner with the center of the wafer substrate A as nearly a center point, the gas feed ports 1, 2 are arranged to be corresponded to the sections, and at least either the flow rate or the concentration (8, 9) of the film-forming reaction gas fed to any one of the sections is adjusted.

### BACKGROUND OF THE INVENTION

The present invention relates to a method of growing a thin film in gaseous phase and to an apparatus for growing a thin film in gaseous phase for use in the above method. More specifically, the invention relates to a method of growing a thin film in gaseous phase maintaining excellent in-plane uniformity concerning the film thickness and the resistivity on the surface of a wafer substrate such as silicon wafer or the like, and to an apparatus for growing a thin film in gaseous phase for use in the above method.

### PRIOR ART

Owing to their various advantages over the batchwise apparatuses, the piece-by-piece type wafer processing apparatuses are now finding spreading use in the field of semiconductor industries as represented by a high-rotational-speed piece-by-piece type apparatus which is now indispensable for growing a thin film in gaseous phase for forming a film maintaining uniform in-plane properties on the wafers of large diameters.

A conventional piece-by-piece type apparatus for growing a thin film in gaseous phase will now be described with reference to FIG. 3 which is a sectional view schematically illustrating the piece-by-piece type apparatus for growing a thin film in gaseous phase.

As shown, the conventional piece-by-piece type apparatus for growing a thin film includes plural gas feed ports 1 formed in an upper part of a rector for feeding starting gases and a carrier gas into the reactor, flow stabilizer plates 3 having plural holes formed therein for stabilizing the flow of gases fed through the gas feed ports 1, a susceptor 4 provided under the flow stabilizer plates 3 and for placing a wafer substrate A thereon, a rotary shaft 5 for rotating the susceptor 4, a heater (not shown) for heating the wafer substrate A, and drain ports (not shown) formed in a lower part of the reactor (usually, near the bottom) to discharge waste gases containing unreacted gases from the interior of the reactor.

As described above, the piece-by-piece type apparatus for growing a thin film is constituted roughly by a gas feed system for feeding film-forming reaction gases such as starting gases and a carrier gas, and a reactor system for growing the thin film.

In order to grow a thin silicon film on the wafer substrate such as silicon wafer in gaseous phase by using the above-mentioned apparatus, first, a film-forming reaction gas is fed through the gas feed ports, the film-forming reaction gas being obtained by diluting a starting gas containing a silicon component as represented by monosilane (SiH₄) and a dopant gas such as diborane with a carrier gas such as hydrogen. In order to uniformalize the momentum of the gases and the distribution of pressure, here, the gas stream is permitted to flow down through the flow stabilizer plates and is brought into contact with the wafer substrate to grow a thin film in gaseous phase.

In order to form a thin film having uniform thickness and uniform electric properties over the whole surface of the film by using the rotary piece-by-piece type apparatus, it is very important to uniformalize the flow of gas in the reactor.

It is, however, very difficult to completely uniformalize the flow of gas in the furnace. In particular, it is difficult to uniformalize the flow of gas by completely controlling the state of gas flow in the furnace in an apparatus of a large capacity capable of handling a wafer of a large diameter.

In the conventional piece-by-piece type apparatus for growing a thin film in gaseous phase, therefore, the flow rate of the film-forming reaction gas fed from the upper part of the reactor and the density of the starting gas in the gas vary depending upon the central part and the outer peripheral part of the wafer substrate that is placed and, besides, the temperature distribution of from about 5 to about 15° C. occurs in the in-plane temperature of the wafer substrate that is heated.

Because of these reasons, therefore, the thin film formed on the surface of the wafer becomes thick at the central portion on the surface of the wafer substrate and thin toward the outer peripheral portion as shown in FIG. 6. Or, as shown in FIG. 8, the film becomes thin at the central portion on the surface of the wafer substrate and thick toward the outer peripheral portion. Besides, the resistivity varies being affected by the automatic doping from the front surface side and from the back surface side of the wafer. In the outer peripheral portion, in particular, the effect is serious. As shown in FIG. 7, for example, the resistivity becomes high in the central portion of the disk and becomes low toward the outer peripheral portion. As shown in FIG. 9, further, the resistivity may become low in the central portion of the disk and becomes high toward the outer peripheral portion.

### SUMMARY OF THE INVENTION

The present invention was accomplished in order to solve the above-mentioned technical problem, and has an object of providing a method of growing a thin film in gaseous phase by using an apparatus for forming a thin film in gaseous phase by feeding a gas-forming reaction gas such as a starting gas from the upper part of the reaction furnace so as to flow down thereby to grow a thin film on a wafer substrate such as a silicon wafer, i.e., to glow a DVD film or an epitaxial film maintaining a thickness which is uniform over the whole surface of the film and uniform electric properties such as resistivity, etc.

It is another object of the present invention to provide an apparatus for growing a thin film in gaseous phase, which is suited for conducting the method of growing a thin film in gaseous phase.

The present invention is concerned with a method of growing a thin film in gaseous phase by flowing down a film-forming reaction gas through plural gas feed ports formed in the top portion of a cylindrical reactor of an apparatus for glowing a thin film in gaseous phase via flow stabilizer plates, and bringing the film-forming reaction gas into contact with the wafer substrate placed on a rotary susceptor disposed on the lower side thereby to grow a thin film on the surface of the substrate, wherein:

space formed by the inner wall at the top portion of the reactor and the flow stabilizer plates is sectionalized into plural spatial sections in a concentric manner with the center of the wafer substrate as nearly a center point;

the gas feed ports are arranged to be corresponded to the sections; and

at least either the flow rate or the concentration of the film-forming reaction gas fed to any one of the sections is adjusted.

Here, it is desired that the flow rate of the film-forming reaction gas is gradually increased or is gradually decreased from the section on the side of the central portion toward the section on the side of the outer peripheral portion, so that the film-forming rate is nearly equalized over the whole region of the wafer substrate.

It is, further, desired that the concentration of the film-forming reaction gas is gradually increased or is gradually decreased from the section on the side of the central portion toward the section on the side of the outer peripheral portion, so that the resistivity is nearly equalized over the whole region of the wafer substrate.

It is, further, desired that the concentration of the dopant in the film-forming reaction gas is gradually decreased or is gradually increased from the section on the side of the central portion toward the section on the side of the outer peripheral portion, so that the resistivity is nearly equalized over the whole region of the wafer substrate.

It is, further, desired to adjust two or three of the flow rate of the film-forming reaction gas, the concentration of the starting gas in the film-forming reaction gas and the concentration of the dopant in combination, so that the film-forming rate and the resistivity are nearly equalized over the whole region of the wafer substrate.

In growing a thin film in gaseous phase on a wafer substrate, the method of growing the thin film in gaseous phase of the invention uses an apparatus for growing the thin film in gaseous phase in which space defined by the inner wall at the top portion of the reactor and by the flow stabilizer plates, is sectionalized into plural spatial sections in a concentric manner with the center of the wafer substrate as nearly a central point, and wherein the gas flow rate and/or the concentration are changed for each of the sections, so that the film-forming rate on the outer peripheral portion of the wafer substrate becomes nearly equal to the film-forming rate at the central portion, in order to uniformalize the thickness and the resistivity of the thin film formed on the surface of the substrate.

In the method of growing a thin film in gaseous phase of the present invention, further, the flow rate of the film-forming reaction gas is gradually increased or decreased from the section on the side of the central portion toward the section on the side of the outer peripheral portion, or the concentration of the starting gas in the gas is gradually increased or decreased from the side of the central portion toward the side of the outer peripheral portion, or the concentration of the dopant in the gas is gradually decreased or increased, or two or three thereof are executed in combination, so that the film-forming rate and the resistivity on the outer peripheral portion of the wafer substrate become nearly equal to the film-forming rate and the resistivity of the central portion thereof.

The present invention is further concerned with an apparatus for growing a thin film in gaseous phase having plural gas feed ports formed in the top portion of the cylindrical reactor, drain ports in the bottom portion, a rotary susceptor for placing a wafer substrate thereon in the reactor, and gas flow stabilizer plates at the upper part in the furnace, so that a film-forming reaction gas flows down in the furnace through the gas feed ports via the flow stabilizer plates so as to glow a thin film in gaseous phase on the wafer substrate on the susceptor of the lower side, wherein:

space defined by the inner wall at the top of the reactor and by the flow stabilizer plates is divided by partitioning walls into plural spatial sections in a concentric manner with the center of the wafer substrate as nearly a center point;

the gas feed ports are arranged to be corresponded to the sections; and

means is provided to feed the film-forming reaction gas to the gas feed ports while adjusting at least either the flow rate or the concentration of the film-forming reaction gas.

Here, it is desired that the partitioning walls are extending toward the lower side of the flow stabilizer plates.

According to the apparatus for growing a thin film in gaseous phase according to the present invention as described above, space defined between the inner wall at the top of the reactor furnace and by the flow stabilizer plates is divided into plural spatial sections in a concentric manner with the center of the wafer substrate as nearly a center point, and the flow rate and/or the concentration of the gas are changed for each of the sections, enabling the film-forming rate and the resistivity of the outer peripheral portion of the wafer substrate to become nearly equal to the film-forming rate and the resistivity of the central portion, in order to uniformalize the thickness and the resistivity of the thin film formed on the surface of the substrate.

The partitioning walls extend to the lower side of the flow stabilizer plates, and the streams of the film-forming reaction gas from different sections flowing down through the flow stabilizer plates are not readily mixed together and, hence, the in-plane film thickness and resistivity are uniformalized to an excellent degree. Besides, disturbance in the gas streams flowing down in the furnace is suppressed permitting the formation of little particles.

### BRIEF DESCRIPTION OF THE DRAWINGS

FIG. 1 is a sectional view schematically illustrating an embodiment of an apparatus for growing a thin film in gaseous phase used in the method of growing a thin film in gaseous phase of the present invention;

FIG. 2 is a sectional view schematically illustrating another embodiment of the apparatus for growing a thin film in gaseous phase used in the method of growing a thin film in gaseous phase of the present invention;

FIG. 3 is a sectional view schematically illustrating a conventional piece-by-piece type apparatus for growing a thin film in gaseous phase;

FIG. 4 is a diagram illustrating a distribution of the in-plane thickness of the thin film according to an Example;

FIG. 5 is a diagram illustrating a distribution of the in-plane resistivity of the thin film according to the Example;

FIG. 6 is a diagram illustrating a distribution of the in-plane thickness of the thin film according to Comparative Example 1;

FIG. 7 is a diagram illustrating a distribution of the in-plane resistivity of the thin film according to Comparative Example 1;

FIG. 8 is a diagram illustrating a distribution of the in-plane thickness of the thin film according to Comparative Example 2; and

FIG. 9 is a diagram illustrating a distribution of the in-plane resistivity of the thin film according to Comparative Example 2.

### DETAILED DESCRIPTION OF THE INVENTION

The invention will now be concretely described with reference to the drawings.

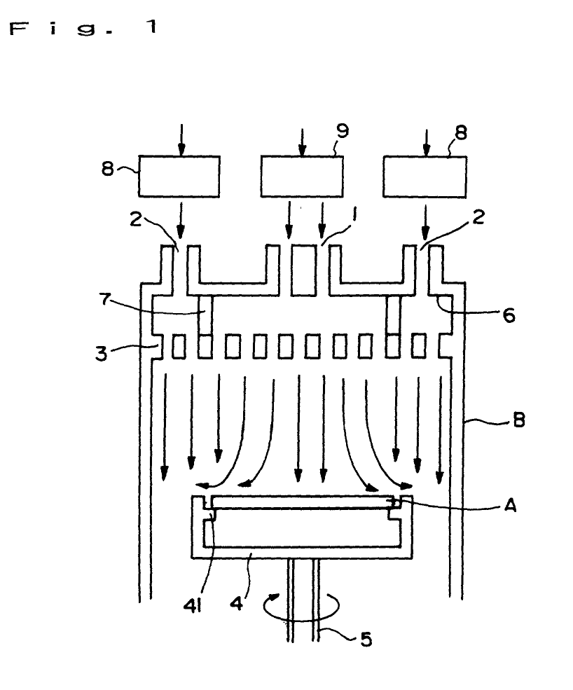

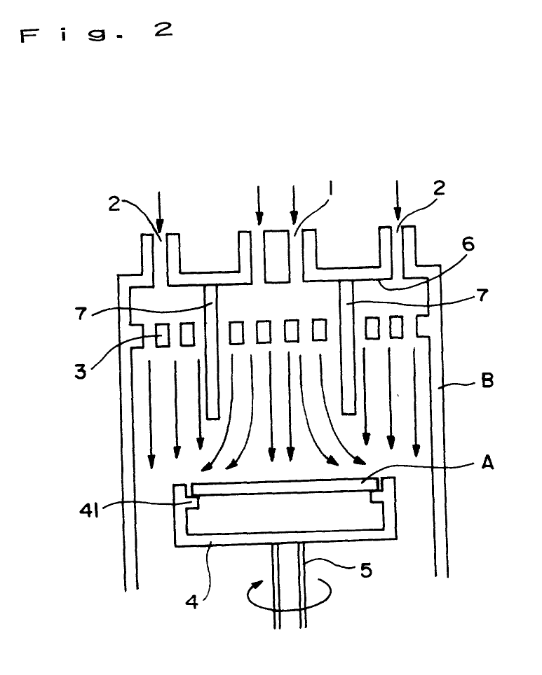

FIG. 1 is a sectional view schematically illustrating an embodiment of an apparatus for growing a thin film in gaseous phase used in the method of growing a thin film in gaseous phase according to the present invention, and wherein the arrows schematically illustrate the flow of gas streams in the furnace. FIG. 2 is a sectional view schematically illustrating another embodiment of the apparatus of the present invention, in which partitioning walls provided between the inner wall at the top of the furnace and the flow stabilizer plates, are extending toward the lower side of the flow stabilizer plates. Like in FIG. 1, the arrows in FIG. 2 schematically illustrate the flow of gas streams in the furnace.

As shown in FIGS. 1 and 2, the piece-by-piece type apparatus for growing a thin film in gaseous phase according to the present invention includes a nearly cylindrical reactor B (chamber) usually made of quartz, gas feed ports 1 and 2 formed in the upper part of the reactor B for feeding a film-forming reaction gas into the furnace, flow stabilizer plates 3 provided under the gas feed ports 1, 2 and having plural through holes formed therein for stabilizing the flow of gas, a susceptor 4 provided under the flow stabilizer plates 3 and having, on the upper surface thereof, a seat 41 for placing a wafer substrate A, a rotary shaft 5 for rotating the susceptor 4, a heater (not shown) for heating the wafer substrate A placed on the seat 41, a motor (not shown) for rotating the rotary shaft 5, and drain ports (not shown) for discharging the waste gas containing unreacted gases in the chamber.

The apparatus according to the present invention has a feature in that space between the inner wall 6 at the top of the reactor B and the flow stabilizer plates 3 is sectionalized by partitioning walls 7 into plural sections in a concentric manner with the center of the wafer substrate A as a center point, the gas feed ports 1, 2 are arranged in these sections, and provision is made of means or flow rate (concentration) adjusting means 8 and 9 for adjusting at least either the flow rate or the concentration of the film-forming reaction gas fed to the gas feed ports. In FIG. 1, flow rate (concentration) adjusting means 8 and 9 are provided for the gas feed ports 1 and 2. However, either one of them only may be provided.

FIG. 1 illustrates a case where space between the inner wall 6 at the top of the reactor B and the flow stabilizer plates 3 is divided into two in a concentric manner with the center of the wafer substrate A as a center point. Not being limited thereto only, however, the space may be divided into three sections or four sections.

When the flow rate (concentration) adjusting means 8 and 9 are flow rate adjusting means, there may be employed widely known flow rate control valves.

When the flow rate (concentration) adjusting means 8 and 9 are concentration adjusting means, too, there may be also employed widely known flow rate control valves.

In the above-mentioned apparatus, the film-forming reaction gas fed through the gas feed ports 1 is stabilized through the flow stabilizer plates 3, flows down to the central portion of the wafer substrate A from the upper side, reaches the upper part on the surface of the wafer, and reacts on the surface of the wafer while flowing toward the outer peripheral direction, thereby to form a thin film on the surface at the central portion of the wafer substrate A.

On the other hand, the film-forming reaction gas fed through the gas feed ports 2 is similarly stabilized through the flow stabilizer plates 3, flows down to the outer peripheral portion of the wafer substrate from the upper side, reaches the upper part on the surface of the wafer, and reacts on the surface of the wafer while flowing toward the outer direction, thereby to form a thin film on the surface of the outer peripheral portion of the wafer substrate.

Here, the feeding rate or the concentration of the film-forming reaction gas is controlled for each of the sections, so that the film-forming rate on the outer peripheral portion, which is lower or higher than that at the central portion of the wafer substrate A, becomes nearly equal to the film-forming rate at the central portion.

The flow rate (concentration) can be adjusted by, for example, gradually increasing or decreasing the gas flow rate from the section on the side of the central portion toward the section of the outer peripheral portion, gradually increasing or decreasing the concentration of the starting gas such as SiH₄ concentration in the film-forming reaction gas from the central side toward the outer peripheral side, gradually decreasing or increasing the concentration of the dopant such as diborane in the gas, or by effecting two or three of the above methods in combination.

FIG. 2 illustrates another embodiment of the apparatus according to the present invention. In this apparatus, the partitioning walls 7 extend toward the lower side of the flow stabilizer plates 3, so that the streams of the film-forming reaction gas flowing through different sections being fed from the feed ports 1 and 2 will not be readily mixed together even after having passed through the flow stabilizer plates.

Like the apparatus shown in FIG. 1, therefore, this apparatus exhibits not only an excellent effect for uniformalizing the in-plane film thickness and resistivity but also suppresses disturbance in the gas stream flowing through the reactor offering, as a result, an advantage of lowering the formation of particles.

As a substrate for forming a thin film in the method of the present invention, a silicon wafer can be typically used, but it is also allowable to use a semiconductor substrate other than silicon, such as silicon carbide substrate or the like substrate.

The thin film formed on the semiconductor substrate stands for a silicon film which may be a single crystalline film, a polycrystalline film or an pitaxial crystalline film without any trouble.

As the film-forming reaction gas used for the gaseous phase growth in the present invention, there can be used, without any particular limitation, the film-forming gas used for the formation of a thin silicon film by an ordinary CVD thin film-growing method. Examples of the film-forming reaction gas may be the one comprising a starting gas containing a silicon component, a dopant and a carrier gas.

As the silicon component of the starting gas, there can be exemplified SiH₄, Si₂H₆, SiH₂Cl₂, SiHCl₃ and SiCl₄. As the dopant gas, there can be exemplified a boron compound such as B₂H₆, a phosphorous compound such as PH₃, as well as AsH₃ and the like.

As the carrier gas, there is usually used a hydrogen gas, an argon gas or the like gas.

According to the method of the present invention as described already, the feeding rate (flow rate) and concentration of the film-forming reaction gas are varied for each of the sections to adjust the film-forming rates on the central portion and on the outer peripheral portion of the wafer substrate. when the film-forming rate is adjusted by adjusting the rate of feeding the film-forming reaction gas and when space is divided into two spatial sections, the m ratio of the flow rate through the section of the central portion and the flow rate through the section of the outer peripheral portion is usually set to be in a range of from about 1:0.25 to about 1:4. When space is divided into three spatial sections, the ratio of the flow rate through the section at the central portion, the flow rate through intermediate section and the flow rate through section of the outer peripheral portion is usually set in a range of from about 1:0.5:0.25 to about 1:2:4.

As described above, the flow rate of the film-forming reaction gas gradually increases or decreases from the section on the side of the central portion toward the section on the side of the outer peripheral portion to nearly equalize the film-forming rate over the whole wafer substrate.

When the film-forming rate is adjusted by adjusting the concentration of the starting gas such as SiH₄, the ratio of the concentration in the section of the central portion and the concentration in the section of the outer peripheral portion, in the case of the two spatial sections, is set to be in a range of from about 1:0.25 to about 1:4 (the flow rate remains the same). In the case of the three spatial sections, the ratio of the concentration in the section of the central portion, the concentration in the intermediate section and the concentration in the section of the outer peripheral portion is usually set to be in a range of from about 1:0.5:0.25 to about 1:2:4.

Thus, the concentration of the starting gas in the film-forming reaction gas is gradually increased or decreased from the section on the side of the central portion to nearly equalize the film-forming rate over the whole wafer substrate.

Similarly, when the resistivity is adjusted by adjusting the concentration of the dopant, the ratio of the concentration in the section of the central portion and the concentration in the section of the outer peripheral portion is set to be in a range of from about 1:4 to about 1:0.25 (the flow rate remains the same) in the case when space is divided into two spatial sections and the dopant is diborane. When space is divided into three spatial sections, the ratio of the concentration in the section of the central portion, the concentration in the intermediate section and the concentration in the section of the outer peripheral portion is usually set in a range of from about 1:2:4 to about 1:0.5:0.25.

As described above, the dopant in the film-forming reaction gas is gradually decreased or increased from the section on the side of the central portion toward the section on the side of the outer peripheral portion to nearly equalize the resistivity over the whole wafer substrate.

Further, two or three of the adjustment of the flow rate of the film-forming reaction gas, adjustment of the concentration of the starting gas in the film-forming reaction gas and adjustment of the dopant concentration, may be effected in combination to nearly equalize the film-forming rate and the resistivity on the whole region of the wafer substrate. The number of the sections is in no way limited to two sections or three sections, but may be suitably selected.

Further, the apparatus should desirably permit the partitioning walls to be expanded or contracted in the radial direction about the center of the circle, since it enables the area ratio of the sections to be changed to meet the size of the wafer substrate to be processed and the processing conditions.

There may be further provided partitioning walls of different diameters, and the partitioning wall having a predetermined diameter may be used as required.

### EXAMPLES

### Example 1

By using a gaseous phase thin film-growing apparatus (having two sections of the central portion and the outer peripheral portion, and a concentric circular partitioning wall between the inner wall at the top of the reactor and the flow stabilizer plates) shown in FIG. 1, a film-forming reaction gas (starting gas: SiH₄ 0.75 g/min, carrier gas: H₂ 30 liters/min, dopant: B₂H₆ 0.4 ppb) was fed through the gas feed ports 1 (section of the central portion), and a film-forming reaction gas (starting gas: SiH₄ 0.75 g/min, carrier gas: H₂ 30 liters/min, dopant: B₂H₆ 0.1 ppb) was fed through the gas feed ports 2 (section of the outer peripheral portion), in order to grow a thin film on a silicon wafer substrate under the operation conditions of a gaseous phase growing temperature of 1000° C., gaseous phase growing pressure of 15 torr, and a holder rotational speed of 1200 rpm.

The obtained thin film was evaluated for its dispersion in the film thickness and dispersion in the resistivity. The results were as shown in Table 1.

As the silicon wafer, there was used a heavily boron-doped crystal (100)(resistivity: ˜10 mΩ·cm). The target setpoint values of the thickness and resistivity of the thin film by the above film-forming testing were 3.0 μm and 3.0 Ω·cm.

Uniformities (distributions of dispersion) of the film thickness and the resistivity were calculated according to the following formula,

Dispersion=(max. value−min. value)/(max. value+min value)

### Example 2

A thin film was formed in the same manner as in Example 1 but changing the flow rates and the composition of the film-forming reaction gas fed through the gas feed ports 1 and 2 as shown in Table 1. The obtained thin film was evaluated in the same manner as in Example The results were as shown in Table 1.

### Example 3

A thin film was formed in the same manner as in Example 1 but using a thin film gaseous phase growing apparatus (having two sections of the central portion and the outer peripheral portion, and a concentric circular partitioning wall protruding downward beyond the flow stabilizer plates by 20 cm from the inner wall at the top of the reactor) shown in FIG. 2. The obtained thin film was evaluated in the same manner as in Example 1. The results were as shown in Table 1.

### Example 4.

A thin film was formed in the same manner as in Example 3 but changing the flow rates and the composition of the film-forming reaction gas fed through the gas feed ports 1 and 2 as shown in Table 1. The obtained thin film was evaluated in the same manner as in Example 3.

The results were as shown in Table 1.

### Comparative Examples 1 and 2

The reaction for forming a thin film was conducted under the same conditions as in Example 1 but using a conventional thin film-growing apparatus shown in FIG. 3 and by feeding, through the feed ports, the film-forming reaction gases of flow rates and compositions shown in the columns of Comparative Examples 1 and 2 in Table The evaluated results of the obtained thin films were as shown in Table 1.

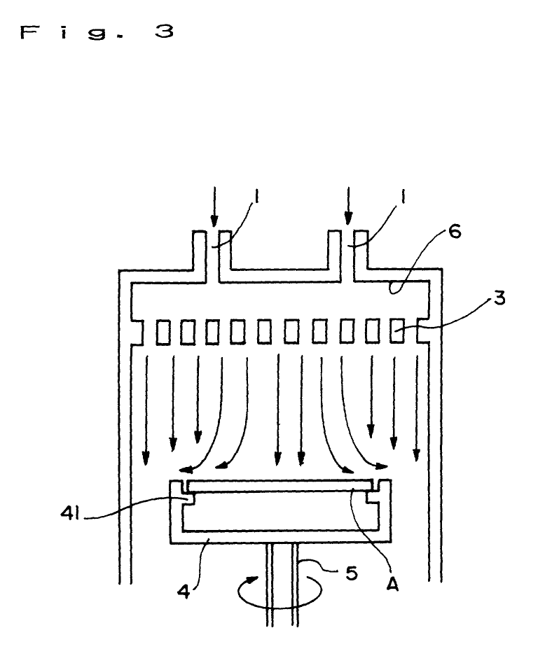

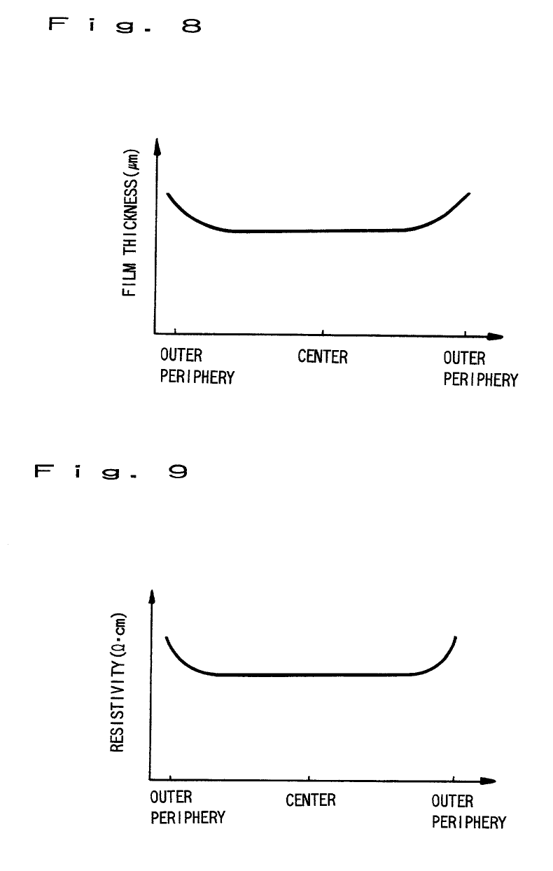

Among the laminated thin films formed in the above Examples and comparative Examples, the laminated thin film of Comparative Example 1 possessed a thickness that became convex at the central portion of the silicon wafer substrate compared to the peripheral portion (see FIG. 6), and the laminated thin film of Comparative Example 2 possessed a thickness that became concave at the central portion of the silicon wafer substrate compared to the peripheral portion (see FIG. 8), whereas the laminated thin films of Examples 1 to 4 all exhibited a nearly flat film thickness distribution though the outer peripheral portion was slightly thick (see FIG. 4).

The dispersion was from 5.4 to 8.7% in Comparative Examples, and was from 0.8 to 2.1% in Examples. Thus, the dispersion in Examples was very smaller than that of the films of Comparative Examples.

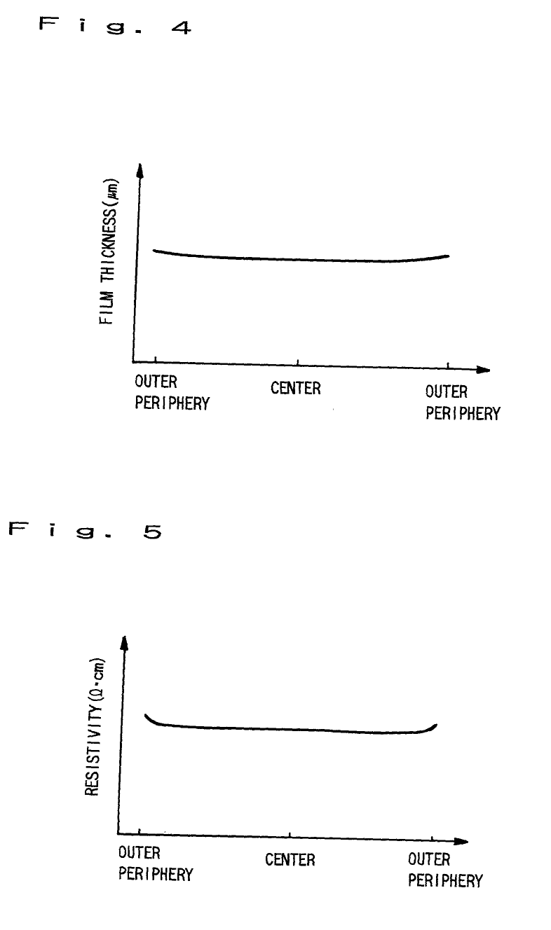

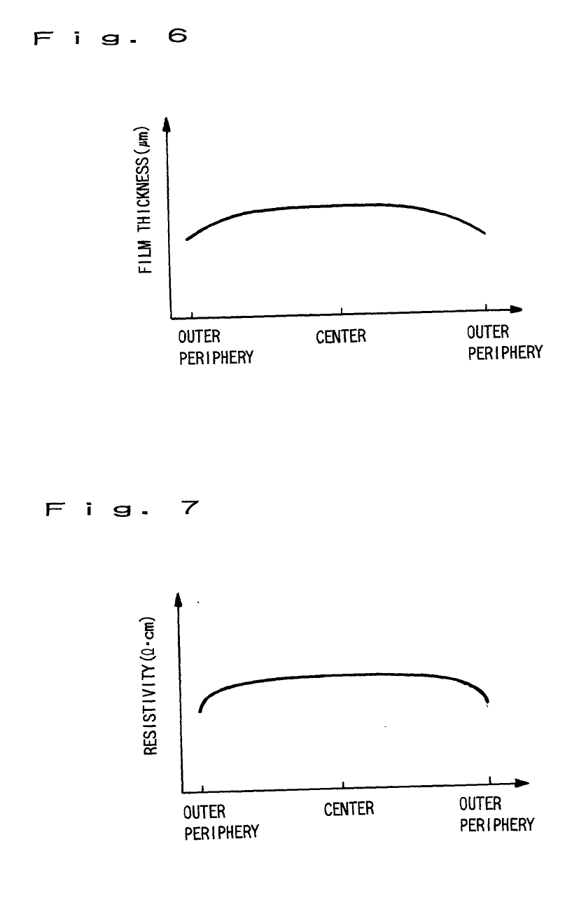

As for the distribution of resistivities of the thin films, the thin film of Comparative Example 1 exhibited a convex distribution which is higher at the central portion of the silicon wafer substrate than at the peripheral portions (see FIG. 7), and the thin film of Comparative Example 2 exhibited a concave distribution which is lower at the central portion of the silicon wafer substrate than at the peripheral portions (see FIG. 9). In Examples 1 to 4, on the other hand, the distributions of resistivities were nearly flat though the distribution was slightly small in the outer peripheral portion (see FIG. 5).

The dispersion was from 8 .5 to 12.1% in Comparative Examples, and was from 1.5 to 3.1% in Examples. Thus, the dispersion in Examples was very smaller than that of the films of Comparative Examples.

TABLE 1

| | Feed port1 | | | Feed port2 | | | | |
|---|---|---|---|---|---|---|---|---|
| | Carrier/material/dopant | | | Carrier/material/dopant | | | Dispersion in | Dispersion in |
| | l/min | g/min | ppb | l/min | g/min | ppb | thickness (%) | resistivity (%) |
| Ex. 1 | 30 | 0.75 | 0.4 | 30 | 0.75 | 0.1 | 2.1 | 3.1 |
| Ex. 2 | 13 | 0.3 | 0.2 | 27 | 0.44 | 0.8 | 1.4 | 1.5 |
| Ex. 3 | 30 | 0.75 | 0.4 | 30 | 0.75 | 0.1 | 1.5 | 1.9 |
| Ex. 4 | 20 | 0.4 | 0.2 | 20 | 0.75 | 0.05 | 0.8 | 1.7 |
| Comp. | 60 | 1.5 | 0.4 | — | — | — | 5.4 | 8.5 |
| Ex. 1 | | | | | | | | |
| Comp. | 40 | 1.1 | 0.3 | — | — | — | 8.7 | 12.1 |
| Ex. 2 | | | | | | | | |

The present invention makes it possible to control the thickness and resistivity of a thin film grown on a silicon wafer and, hence, to improve uniformity in the in-plane distribution of thicknesses and resistivities of the thin film.

What is claimsed is:

1. A method of growing a thin film in gaseous phase by flowing down a film-forming reaction gas through plural gas feed ports formed in the top portion of a cylindrical reactor of an apparatus for glowing a thin film in gaseous phase via flow stabilizer plates, and bringing the film-forming reaction gas into contact with the wafer substrate placed on a rotary susceptor disposed on the lower side thereby to grow a thin film on the surface of the substrate, wherein:
space formed by the inner wall at the top portion of the reactor and the flow stabilizer plates is sectionalized into plural spatial sections in a concentric manner with the center of the wafer substrate as nearly a center point;
the gas feed ports are arranged to be corresponded to the sections; and
at least either the flow rate or the concentration of the film-forming reaction gas fed to any one of the sections is adjusted.

2. A method of growing a thin film in gaseous phase according to claim 1, wherein the flow rate of the film-forming reaction gas is gradually increased or is gradually decreased from the section on the side of the central portion toward the section on the side of the outer peripheral portion, so that the film-forming rate is nearly equalized over the whole region of the wafer substrate.

3. A method of growing a thin film in gaseous phase according to claim 1, wherein the concentration of the film-forming reaction gas is gradually increased or is gradually decreased from the section on the side of the central portion toward the section on the side of the outer peripheral portion, so that the resistivity is nearly equalized over the whole region of the wafer substrate.

4. A method of growing a thin film in gaseous phase according to claim 1, wherein the concentration of the dopant in the film-forming reaction gas is gradually decreased or is gradually increased from the section on the side of the central portion toward the section on the side of the outer peripheral portion, so that the resistivity is nearly equalized over the whole region of the wafer substrate.

5. A method of growing a thin film in gaseous phase according to any one of claims 1 to 4, wherein two or three of the flow rate of the film-forming reaction gas, the concentration of the starting gas in the film-forming reaction gas and the concentration of the dopant, are executed in combination, so that the film-forming rate and the resistivity are nearly equalized over the whole region of the wafer substrate.

6. An apparatus for growing a thin film in gaseous phase having plural gas feed ports formed in the top portion of the cylindrical reactor, drain ports in the bottom portion, a rotary susceptor for placing a wafer substrate thereon in the reactor, and gas flow stabilizer plates at the upper part in the furnace, so that a film-forming reaction gas flows down in the furnace through the gas feed ports via the flow stabilizer plates so as to glow a thin film in gaseous phase on the wafer substrate on the susceptor of the lower side, wherein:
space defined by the inner wall at the top of the reactor and by the flow stabilizer plates is divided by partitioning walls into plural spatial sections in a concentric manner with the center of the wafer substrate as nearly a center point;
the gas feed ports are arranged to be corresponded to the sections; and
means is provided to feed the film-forming reaction gas to the gas feed ports while adjusting at least either the flow rate or the concentration of the film-forming reaction gas.

7. An apparatus for growing a thin film in gaseous phase according to claim 6, wherein the partitioning walls are extending toward the lower side of the flow stabilizer plates.
